(19) United States
(12) Patent Application Publication
(10) Pub. No.: US 2026/0063184 A1
(43) Pub. Date: Mar. 5, 2026

(54) Vibration damper and related methods

(71) Applicant: Darden Lee Wall, JR., San Antonio, TX (US)

(72) Inventor: Darden Lee Wall, JR., San Antonio, TX (US)

(21) Appl. No.: 18/823,220

(22) Filed: Sep. 3, 2024

(51) Int. Cl. F16F 7/10; E04H 12/00; H02G 13/00

(52) U.S. Cl. CPC F16F 7/10; E04H 12/00; F16F 2222/08; F16F 2226/04; H02G 13/00

(57) ABSTRACT

The disclosed damper is designed to minimize first-mode vibration wind-induced resonance in tubular steel lightning masts used in electric substations. It employs a hanging cable system threaded through washers and variously sized caster wheels, addressing resonance vibrations that can lead to structural fatigue and failure. This design ensures consistent engagement with the structure, even with tapered walls, by utilizing different diameter caster wheels at various elevations.

### CROSS-REFERENCE TO RELATED APPLICATIONS

See the Application Data Sheet (ADS).

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if applicable.

### BACKGROUND OF THE INVENTION

### Field of Invention

The disclosed subject matter pertains to vibration damping systems specifically designed for tall, slender masts and other structures. These systems aim to mitigate swaying oscillations or vibrations while effectively managing wind-induced vortices.

### Background of the Invention

Modern electrical grids, comprising interconnected networks for electricity delivery, often include substations. These substations transform electricity from high to low voltage or redirect it across different grid routes. Due to their electrical nature, substations are prone to lightning strikes during adverse weather, necessitating the installation of lightning masts for the protection of the substation's valuable equipment.

Lightning masts are tall, typically ranging from 50 to over 100 feet in height. The masts are conical tubes wider at the base and tapering towards the top for stability. While some masts have circular cross-sections, cost-effective designs often feature sharp-cornered cross-sections such as square, pentagonal, hexagonal, octagonal, or decagonal shapes.

These masts experience swaying or oscillation due to a phenomenon called vortex shedding. See Robert F. Wolff, “Design Status Poles Against Wind,” Electrical World, April 1983, pg. 81. This is where wind flowing around the mast creates alternating vortices that pull the mast perpendicular to the wind direction. Id. Masts with sharp corners are more susceptible to severe swaying because these corners fix the points where wind vortices are generated and shed. Id.

Swaying or vibration can become violent or prolonged if it resonates with the mast's natural frequency. Such motion can lead to structural failure. Thus, engineering solutions are implemented to disrupt harmonic movements caused by vortex shedding.

Hanging-chain impact dampers are commonly used to disrupt such swaying or vibration. See Koss, L. L. & Melbourne, W. H., “Chain dampers for control of wind-induced vibration of tower and mast structures,” Engineering Structures, vol. 17, no. 9, pp. 622-625, 1995. These dampers consist of a heavy chain suspended as deadweight from the mast's top, dissipating motion energy through friction between chain links and inelastic impacts with the mast's sidewalls. Id., FIG. 1 at 622 (reproduced in relevant part as FIG. 1 here). The chain's free end and portions along its length impact the mast when swaying becomes severe. Id. For narrow tubular masts, the chain can be hung inside to create multiple impacts during a sway cycle; otherwise, a secondary tube is required. Id. ; see also FIG. 1 (“container”). Chains may be fitted with rubber sleeves or plastic pipes to reduce noise. See Reed, W. H. III, “Hanging-Chain Impact Dampers: A Simple Method for Damping Tall Flexible Structures,” Int'l Research Seminar-Wind Effects on Buildings and Structures, Ottawa, Canada, 11-15 Sep. 1967, pp. 283-321.

Hanging-chain impact dampers became prevalent in the late 1960s after NASA reviewed this technology and found it a simple and predictable (engineerable) way to mitigate wind-induced vibrations of tall flexible towers. Id. at 310; see also FIG. 1. Hanging-chain impact dampers were the industry standard for substation lightning masts by the late 1970s. For instance, Oklahoma Gas & Electric Company's Substation Standard A165 from September 1976, FIG. 5 (reproduced as FIG. 2 here) shows a ⅜ hollow steel chain 3′-0 long (weight 5 lbs) with a plastic pipe insulation as the standard impact damper for a 60′ lightning diverter pole per A900.

Tension cables have been another possible solution to damping vibrations caused by vortex shedding in tall structures. Tension cables are installed inside the structure to alter its natural frequency and avoid resonance vibrations. However, these cables can loosen over time due to stretching and compression of the structure, cable, or fixtures, reducing their effectiveness and increasing noise when they jostle or hit the structure's walls. Maintenance is required to retighten or replace the cables, adding to the cost and complexity of this solution.

Despite their effectiveness, both hanging-chain dampers and tension cables have drawbacks. Impact noises become noticeable when the rubber or plastic sleeves wear out on hanging chains, and tension cables require regular maintenance. Additionally, both solutions are more suited to cylindrical sidewalls than conical ones. Nevertheless, they have remained the industry standards due to their cost-effectiveness and simplicity.

### SUMMARY OF THE INVENTION

The disclosed subject matter is a new damper that maintains the advantages of hanging-chain dampers while addressing the limitations of tension cables. This invention is better suited for conical masts and provides improved reduction of impact noise compared to hanging-chain or tension cable dampers. The disclosed damper utilizes a hanging cable system threaded through washers and variously sized caster wheels to address the challenges posed by tapered mast structures. The cable damper design ensures uniform engagement with the mast, minimizing variations in the gap ratio caused by the mast's taper. The caster wheels offer improved noise reduction upon impact with the mast. This innovation offers a practical, predictable, and inexpensive solution for managing wind-induced vibrations in lightning masts.

The disclosed cable damper comprises a galvanized wire rope cable, typically ranging from ¼″ to ½″ in diameter, depending on the specific requirements of the lightning mast structure. Stacked along the cable are galvanized washers, between about 1/16″ and ⅜″ thick with an outer diameter of 1″ to 3″. The washers provide the necessary mass for damping and create friction as they move against each other during cable flexing, helping to absorb energy from the structure's movement.

Interspersed among the washers are caster wheels, typically 2.5″ to 8″ in diameter and 1″ to 2″ thick. These wheels are strategically placed to maintain a consistent gap ratio along the length of the tapered structure. The caster wheels may be made of various materials, including polyurethane, neoprene, thermo-pro rubber, phenolic, or glass-filled nylon, depending on the environmental conditions and specific structural requirements. This damper, with casters of varying sizes, allows the entire length of the cable damper to more uniformly engage a conical tapered structure experiencing resonance vibrations.

The cable damper is designed to be attached at the mast top cap plate and hang freely inside hollow tubular steel lightning mast structures. When the structure experiences vortex shedding during slow and steady winds, it is pushed back and forth in a perpendicular direction from the wind. As the movement approaches the natural frequency of the structure, resonance vibrations can potentially cause the structure to fail. This cable damper will bump into the inside wall of the structure as it begins to move, and the interaction between the damper and the structure will slow down the structure's movement just enough to help keep the resonance vibrations to a minimum.

The design of the cable damper is customized for each structure based on factors such as mast height, weight, dimensions, natural frequency, and taper of the mast walls. A preliminary design process involves modeling the structure in PLS-POLE software to calculate the natural frequency and total weight. The damper is then designed to weigh at least 5% of the structure's weight, with the cable length typically fitting within the top third of the structure's height.

The assembly process involves cutting the wire rope to the required length and installing a swage button on one end to prevent unraveling. Washers and caster wheels are then threaded onto the cable in a specific sequence, with caster wheels grouped approximately 12 inches apart to ensure the clearance gap remains within ±7% of each other. This strategic placement helps maintain a consistent gap ratio along the length of the tapered structure. For example, a 100-foot mast with a 0.066288-inch per foot taper, the setup involves eight caster wheels. The first caster is hung 3 feet from the top, with a 4-inch diameter and a clearance gap of 0.949 inch. The second caster is 4 feet from the top, also with a 4-inch diameter and a clearance gap of 1.015 inch. The third caster is 5 feet from the top, with a clearance gap of 1.081 inch. The fourth caster, 11 feet from the top, has a 5-inch diameter and a clearance gap of 0.979 inch. The fifth caster is 12 feet from the top, with a 5-inch diameter and a clearance gap of 1.045 inch. The sixth, seventh, and eighth casters are 6 inches in diameter, positioned 18, 19, and 20 feet from the top, with clearance gaps of 0.943 inch, 1.009 inch, and 1.076 inch, respectively. Washers are stacked to fill gaps between casters: approximately one foot thick between the first and second, second and third, fourth and fifth, sixth and seventh, and seventh and eighth casters. Between the third and fourth, and fifth and sixth casters, washers are stacked five feet thick (60 inches). A shaft collar is installed near the top, and a thimble eye attachment is created on the free end for securing the damper to the mast top cap plate.

This cable damper offers advantages over traditional methods. It provides improved effectiveness in damping vibrations, has a longer lifespan than PVC-covered chain dampers, and maintains consistent performance across the length of tapered structures. Additionally, it reduces noise and the potential for structural damage while requiring lower maintenance compared to tension cable systems.

The primary application for this cable damper is in electric utility substations, specifically for tall lightning mast structures ranging from 50′ to over 100′ in height. By effectively mitigating wind-induced vibrations, this invention contributes to the longevity and reliability of critical infrastructure in electrical power systems.

### LISTING OF RELATED ART

The art of dampeners is occupied by at least the following references: U.S. Pat. No. 00,728,105 by Hipple et al. (circa 1903) discloses a muffler for noise reduction for fluid escaping a tube; U.S. Pat. No. 02,714,937 by Houle (circa 1955) discloses a chimney silencer for noise reduction of smoke escaping the chimney; U.S. Pat. No. 03,054,471 by Knudsen (circa 1962) discloses acoustic filters for boreholes; U.S. Pat. No. 03,568,805 by Reed III (circa 1971) discloses a suspended mass impact damper; U.S. Pat. No. 03,612,222 by Mine (circa 1971) discloses a pole damping system; U.S. Pat. No. 04,130,185 by Densmore (circa 1978) discloses a pole vibration damper; U.S. Pat. No. 04,350,233 by Buckley (circa 1982) discloses a structural damper for eliminating wind-induced vibrations; U.S. Pat. No. 11,078,890 by Ollgaard (circa 2021) and EP3063405B1 by Ollgaard (circa 2018) disclose an oscillating damper for damping tower harmonics; US20110260379 by Copf (circa 2011) discloses an earthquake damper; US20120063915 by Kawabata et al. (circa 2012) discloses a vibrating control apparatus of wind turbine generator; US20150354791 by Macchietto et al. (circa 2015) discloses a method and apparatus for damping vibrations of poles; US20240141967 by Khan (circa 2024) discloses an electrically isolating tuned mass damper; JP2006226037A & JP2006226038A (circa 2006) disclose a pendulum style damper; JP2007170415A (circa 2007) discloses a pole damper; JPS6065932A (circa 1985) appears to disclose a damper; KR101164068B1 (circa 2012) discloses a damper for poles; and WO2009068599A2 by Ollgaard (circa 2009) discloses a method for damping oscillations in a wind turbine.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 01 is an image of a typical hanging chain damper;

FIG. 02 is an image of a hanging chain damper in a lightning diverter mast;

FIG. 03 is a perspective view of a damper 1000 defined by a hanging cable 1100, at least one set of washers 1200, a first caster 1300, a second caster 1400, a third caster 1500, and fourth caster 1600;

FIG. 04 is an exploded view of the damper 1000 of FIG. 3;

FIG. 05 is a front side view of the damper 1000 of FIG. 3;

FIG. 06 is a back side view of the damper 1000 of FIG. 3;

FIG. 07 is a bottom view of the damper 1000 of FIG. 3;

FIG. 08 is a top view of the damper 10000;

FIG. 09 is a right side view of the damper 1000 of FIG. 3;

FIG. 10 is a left side view of the damper 1000 of FIG. 3;

FIG. 11 is an exploded and assembled view of a section of the damper 1000 of FIG. 3;

FIG. 12 is a front view of the section of damper 1000 shown in FIG. 11 in a hanging configuration;

FIG. 13 is a front view of the damper section of FIG. 11 in a swaying configuration;

FIG. 14 is a front view of the section of damper 1000 of FIG. 11 in an alternative swaying configuration; and,

FIG. 15A is a view of the caster impacting the sidewall 2000 of a mast;

FIG. 15B is a view of an alternate embodiment of the damper impacting the sidewall 2000 of a mast;

FIG. 16 is a table of values implementing a damper with varying caster size and hang-placement for a hundred foot mast with a slope or taper of approximately 0.066 inches per foot.

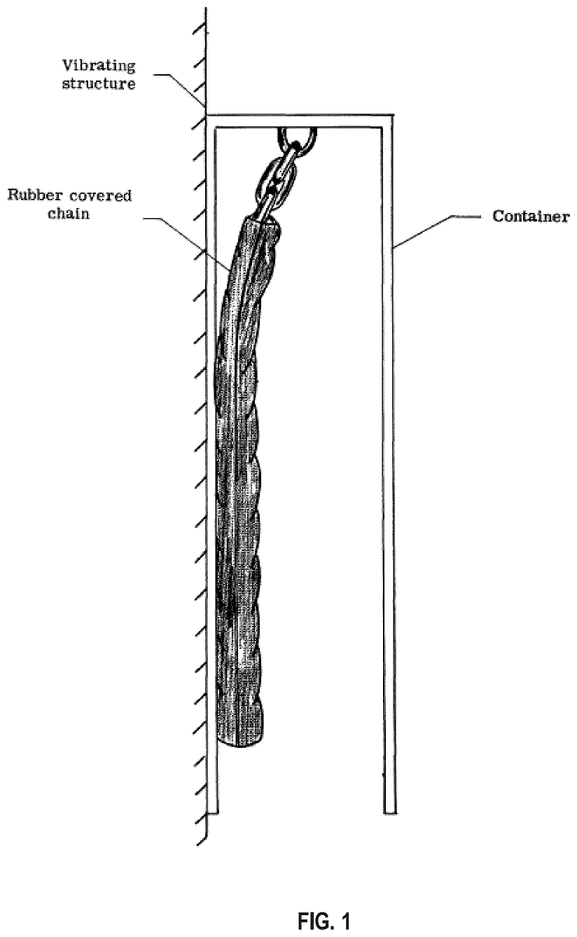

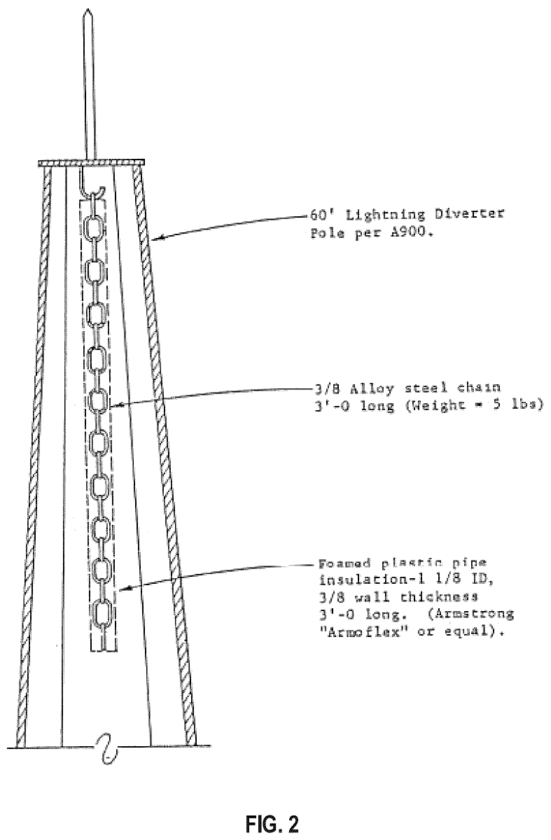

In the drawings, the following reference numerals reflect the following assemblies or components:
Damper 1000
   Cable 1100
      Eye 1110
      Tie 1120
      Collar 1130
      Swage button 1140
   Set of washers 1200
      Washer 1210
First caster 1300
   spanner bushing 1310 (that may act as an axle for the caster)
      spanner bushing bore 1311
   Bore 1320
   Hub 1330
   Core 1340
   Tread 1350
Second caster 1400
   spanner bushing 1410 (that may act as an axle for the caster)
      spanner bushing bore 1411
   Bore 1420
   Hub 1430
   Core 1440
   Tread 1450
Third caster 1500
   spanner bushing 1510 (that may act as an axle for the caster)
      spanner bushing bore 1511
   Bore 1520
   Hub 1530
   Core 1540
   Tread 1550
Fourth caster 1600
   spanner bushing 1610 (that may act as an axle for the caster)
      spanner bushing bore 1611
   Bore 1620
   Hub 1630
   Core 1640
   Tread 1650
Mast sidewall 2000.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFFERED EMBODIMENTS

Disclosed is a damper specifically designed to minimize first-mode vibration wind-induced resonance in tubular steel lightning masts used in electric substations. This innovative damper employs a hanging cable system threaded through washers and variously sized caster wheels. The system addresses the challenge of resonance vibrations that can lead to structural fatigue and failure, particularly in tall, slender tubular steel structures measuring 50 to 100 feet or more. The damper is designed to engage the structure consistently, even with tapered walls, by utilizing different diameter caster wheels at various elevations. The detailed configuration and operation of this damper are elaborated in connection with the attached figures.

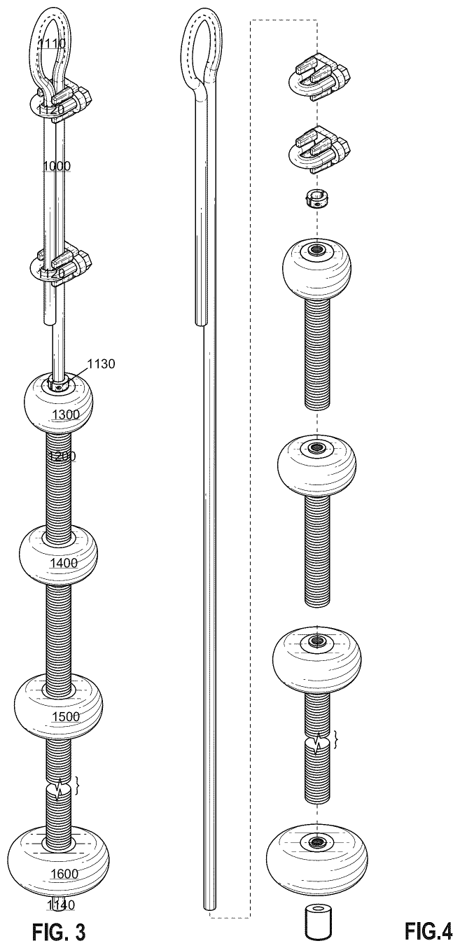

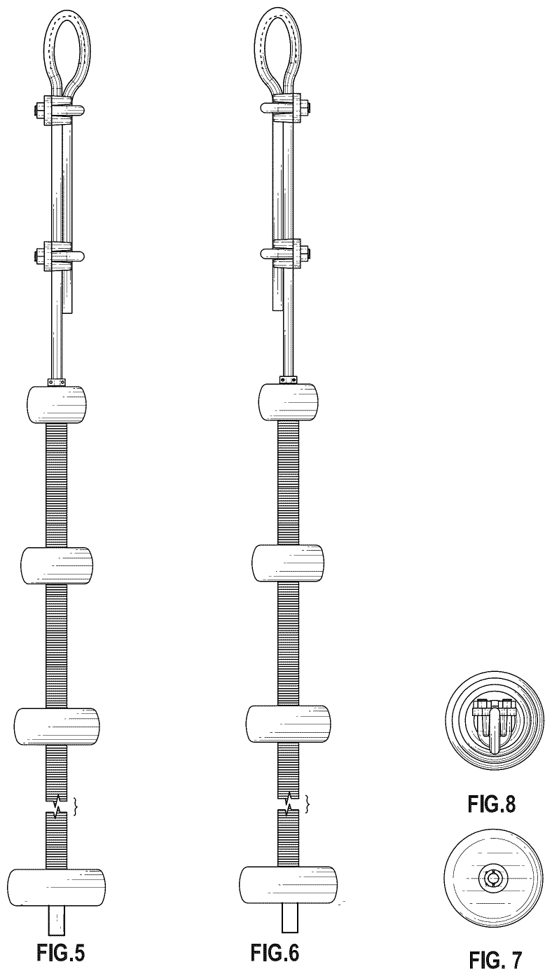

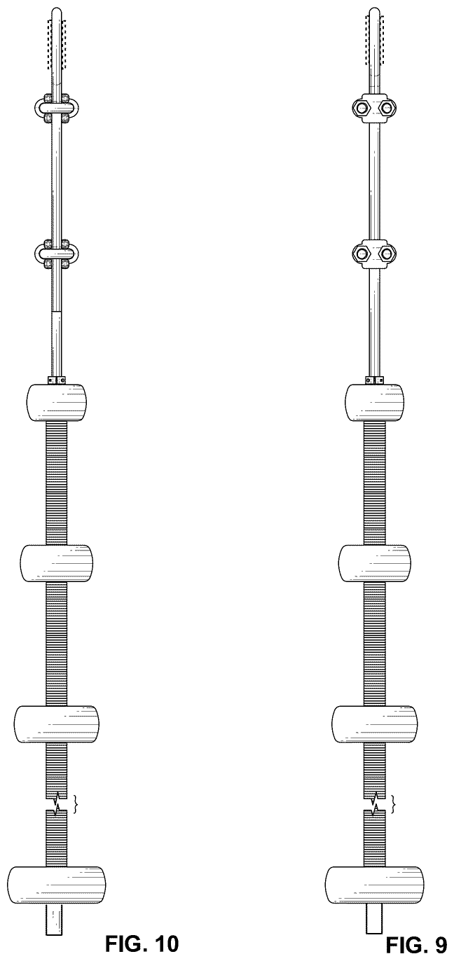

FIG. 03 illustrates a preferred embodiment of the damper 1000. The damper 1000 comprises a hanging cable 1100, at least one set of washers 1200, and four casters: a first caster 1300, a second caster 1400, a third caster 1500, and a fourth caster 1600. The damper 1000 can be suspended from the top inside of a mast using an eye 1110 formed on the cable 1100. This configuration allows the damper to function as a pendulum-style device, effectively reducing vibrations by interacting with the mast's interior walls.

FIG. 03 illustrates a preferred embodiment of the damper 1000. The damper 1000 comprises a hanging cable 1100, at least one set of washers 1200, and four casters: a first caster 1300, a second caster 1400, a third caster 1500, and a fourth caster 1600. The damper 1000 can be suspended from the top inside of a mast using an eye 1110 formed on the cable 1100. This configuration allows the damper to function as a pendulum-style device, effectively reducing vibrations by interacting with the mast's interior walls.

In one embodiment, the cable 1000 is a galvanized wire rope that is typically between ¼″ to ½″ in diameter and approximately 26 feet in length for a 100′ mast. Suitably, the cable 1000 may feature a swage button 1140 or anchor to prevent the cable from unraveling and hold the damper weight. The caster wheels 1600 may be a 6″×2″ wheel made of neoprene. The set of washers 1200 may be 12 inches of galvanized washers of 1/16″ to ⅜″ thick with an outer diameter of 1″ to 3.″ The caster wheels 1500 may be a 5″×2″ wheel made of neoprene. The caster wheel 1400 may be a 4″×2″ wheel made of neoprene. The caster wheel 1300 may be a 3″×2″ wheel made of neoprene. The collar 1130 may be a double split clamp-on shaft collar. The tie 1120 may be a wire rope clips. The eye 1110 may be used to install the damper 1000 on a mast via a round pin shackle.

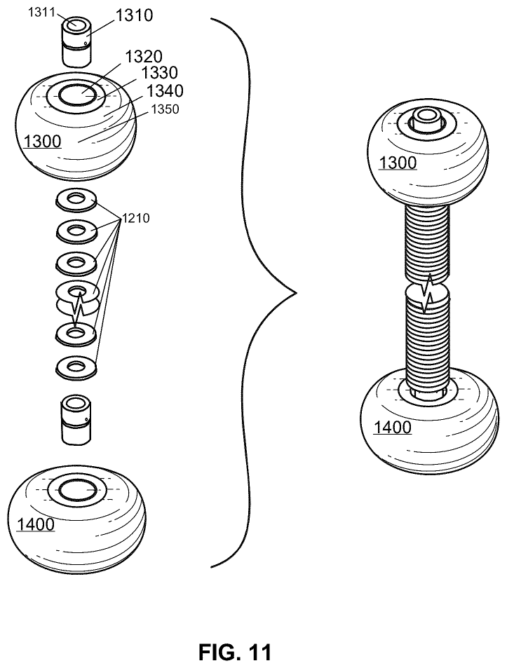

FIG. 11 shows an exploded view of the first caster 1300, the set of washers 1200, and the second caster 1400. The caster 1300 includes a spanner bushing 1310 with a spanner bushing bore 1311 for the cable 1000.The caster 1300 rotates freely around the spanner bushing 1310, facilitated by a bore 1320 that may include ball bearings (or other types of bearings) for reduced friction. The caster features a hub 1330, which hosts the bore 1320 and aligns the tread 1350 radially with the cable 1000. In the preferred embodiment, the weight of all the stacked washers 1200 is transferred through the spanner bushing 1310 to the cable such that the caster should never feel the weights of the washers 1200 weighing on them.

As also shown in FIG. 11, the set of washers 1200 consists of multiple washers 1210, each with a central bore for threading by the cable 1000. These washers are stacked between the first caster 1300 and the second caster 1400, interfacing with the spanner bushings 1310 and 1410. The washers are made of durable metals, while the casters'treads and cores are crafted from impact and sound-absorbing materials like rubber or plastic.

As shown, the washers and spanner bushings are made of durable metals, or the like, while at least the caster 1300/1400 tread 1350/1450 and core 1340/1440 are defined by a durable but sound-absorbing material.

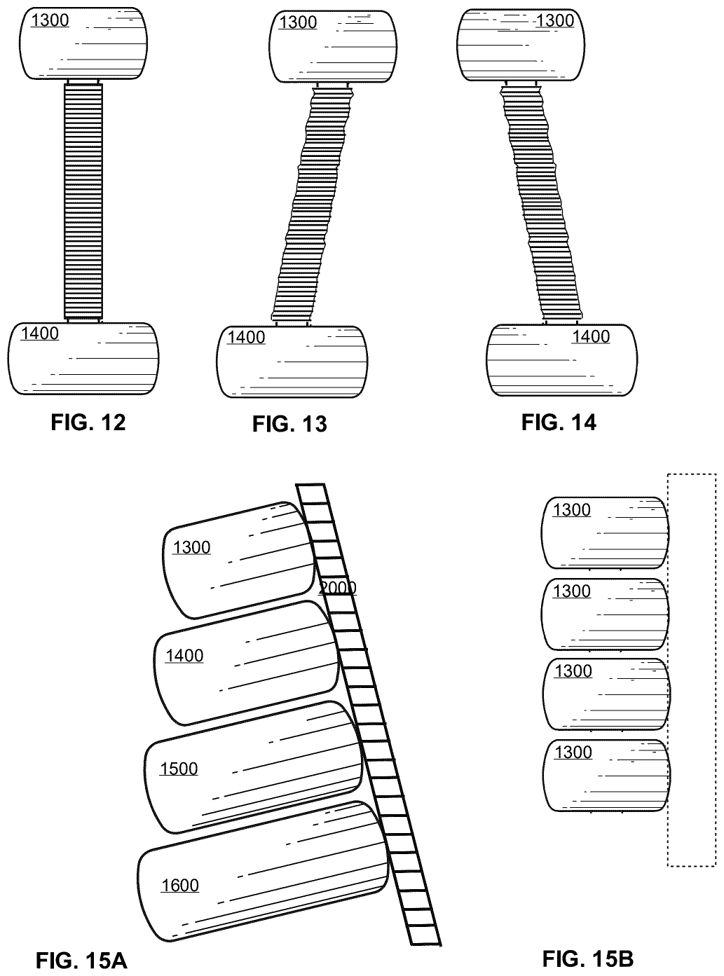

FIG. 12 is a front view of the section of damper 1000 shown in FIG. 11 in a hanging configuration. As shown, the section of the damper hangs as dead weight within a mast (not shown). FIG. 13 is a front view of the damper section of FIG. 11 in a swaying configuration. FIG. 14 is a front view of the section of damper 1000 of FIG. 11 in an alternative swaying configuration. As shown in FIGS. 12 through 14, the interface between the spanner bushings 1310/1410 and the washers 1210 prevents the washers 1210 from damaging the caster 1300/1400 by rubbing against it during operation of the damper 1000. Furthermore, the interface of the washer 1210 in the set of washers 1200 produces friction that is involved in dissipating energy of the motion of the damper 1000. As discussed in further detail below, the damper 1000 may sway within the mast (not shown) until the casters 1300/1400 impact the sidewall of the mast (not shown). Suitably, the casters 1300/1400 prevent the washers and cable from impacting the sidewalls of the mast, whereby the damper and the mast are protected against damage and loud impact noises are prevented. Although the illustration presents casters 1300 and 1400, the same and similar principles or concepts apply to a caster system of casters 1400 and 1500 or casters 1500 and 1600.

Continuing with the description, FIG. 12 depicts the damper 1000 in a hanging configuration within a mast, while FIGS. 13 and 14 show the damper in swaying configurations. The interaction between the spanner bushings and washers prevents damage to the casters during operation. The damper sways until the casters impact the mast's sidewall, helping to control resonance vibrations.

FIG. 15A illustrates the caster impacting the sidewall 2000 of a mast. Each caster 1300, 1400, 1500, and 1600 has uniquely dimensioned cores and treads, allowing them to impact the mast's tapering sidewall at coordinated times. This feature ensures consistent engagement with the structure, effectively minimizing variations in the gap ratio along the damper's length and enhancing its damping efficiency. While the damper is designed with different sized casters to engage the inside wall of the structure uniformly, sometimes there may be instances where the damper does not stay straight relative to the structure. This change in straightness of the damper may be due primarily to the structure bending and moving at the same time as the damper. When this occurs, the damper flexes the washers will slide against each other within the space between the washer's bore and the cable, causing friction between the washers'interfaces. The washers'friction helps dissipate energy from the damper's motion, aiding in vibration reduction. FIG. 15B illustrates a mast with zero slope and a damper with casters that are all approximately the same size.

To construct the preferred embodiment of the damper 1000, begin by preparing a galvanized wire rope as the cable 1000, typically between ¼″ to ½″ in diameter, and cut it to a length of approximately 26 feet, suitable for a 100-foot mast. Secure one end of the cable with a swage button to prevent unraveling and to hold the damper weights. Next, thread a series of galvanized washers 1210, approximately ⅜″×2″ (or with an outer diameter of 1″ to 3″ being appropriate), onto the cable 1000, starting with a few against the swage button 1140. Next, proceed by installing the first large caster wheel 1600, typically a 6″×2″ wheel made of Neoprene, a material known for its durability and sound-absorbing properties. Follow this with approximately 12 inches of a washer group 1200 of additional 1/16″×2″ galvanized washers 1210, then install another large caster wheel 1500, repeating this process to build the initial section of the damper 1000. Continue by threading approximately 60 inches of washers 1210, then install a medium caster wheel 1400, such as a 5″×2″ Neoprene wheel. Follow with another set of washers 1210 and medium caster wheels 1400 as needed. For the final section, thread approximately 12 inches of washers 1200 and install a small caster wheel 1300, typically a 4″×2″ Neoprene wheel, repeating this step as necessary. Once all components are threaded, secure the assembly using a double split clamp-on shaft collar 1130. To create an attachment point, turn back the free end of the cable 1100 onto itself and install a wire rope clips 1120, securing it with two or more wire rope clips to form a thimble eye 1110. This eye 1110 will be used to attach the damper 1000 to the mast's top cap plate using a round pin chain shackle. The final assembly and installation of the damper 1000 occur in the field, where the thimble eye 1110 end of the damper 1000 is pulled into the top section of the lightning mast 2000 and securely attached. Once the damper 1000 is in place, complete the assembly of the lightning mast structure and set it up to finalize the installation. This method ensures that the damper effectively reduces resonance vibrations by engaging the mast's interior walls consistently, even with tapered structures, thanks to the strategic placement and sizing of caster wheels.

The design of the cable damper begins with a thorough analysis of the structure it is intended to protect. Using PLS-POLE software, the dimensions, natural frequency, and total weight of the lightning mast are modeled. This analysis is crucial for understanding the dynamic behavior of the mast under wind-induced forces. The damper is designed to weigh at least 5% of the mast's total weight, ensuring it has sufficient mass to effectively dampen vibrations. The cable length is typically set to fit within the top one-third of the mast's height, targeting the area of greatest movement for maximum damping efficiency.

The cable damper utilizes a galvanized wire rope cable, with diameters ranging from ¼″ to ½″, selected based on the specific requirements of the mast structure. Galvanized washers, approximately 1/16″ to ⅜″ thick with an outer diameter between 1″ to 3″, are chosen to provide the necessary mass for damping. These washers create friction as they move against each other during cable flexing, absorbing energy from the mast's movement. Interspersed among the washers are caster wheels, typically 2.5″ to 8″ in diameter and 1″ to 2″ thick, strategically placed to maintain a consistent gap ratio along the length of the tapered structure.

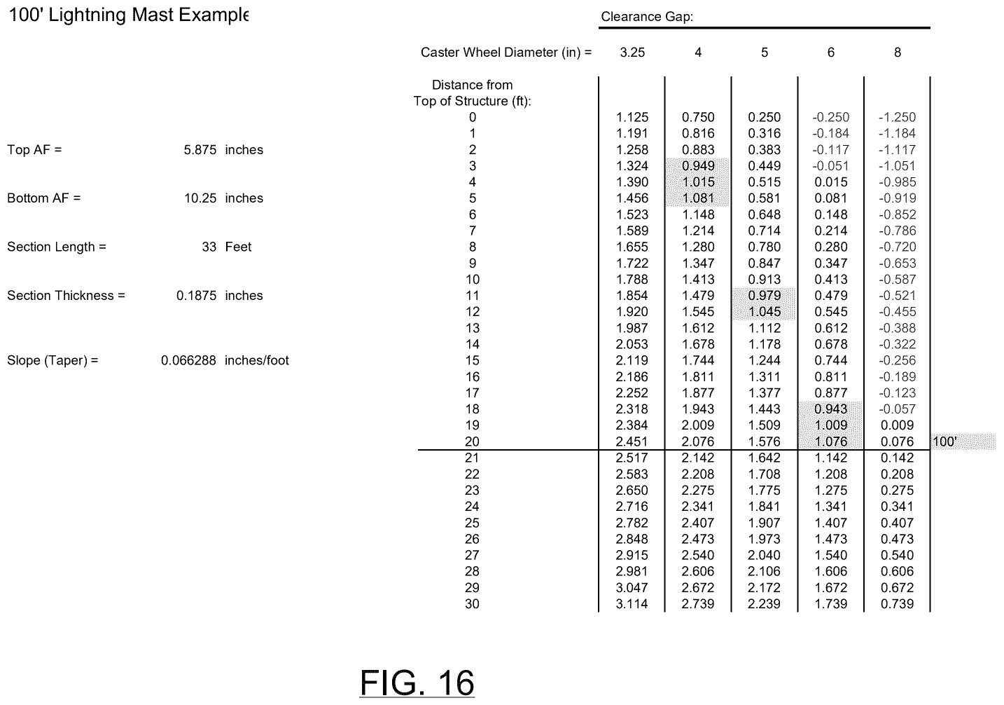

The assembly process involves cutting the wire rope to the required length and installing a swage button on one end to prevent unraveling and to support the damper weight. Washers and caster wheels are then threaded onto the cable in a specific sequence, with caster wheels grouped in areas where they are approximately 12″ apart, ensuring the clearance gap is within ±7% of each other. See FIG. 16. As shown in FIG. 16, a hundred-foot mast with a 0.066288 inch per foot taper or slope has a particular eight caster set up. The first caster wheel is hung 3 ft from the top of the mast, has a four-inch diameter and a clearance gap of 0.949 inch relative to a first point on the inner wall of the tapering or conical mast. The second caster wheel is hung four feet from the top of the mast, has a four-inch diameter and a clearance gap of 1.015 inch relative to a second point on the inner wall of tapering or conical mast. The third caster wheel is hung five feet from the top and has a clearance gap of 1.081 inch relative to a third point on the inner wall of the tapering or conical mast. The fourth caster wheel is hung 11 feet from the top, has a five-inch diameter and a clearance gap of 0.979 inch relative to a fourth point on the inner wall of the tapering or conical mast. The fifth caster wheel is hung 12 feet from the top, has a five-inch diameter and a clearance gap of 1.045 inch relative to a fifth point on the inner wall of the tapering or conical mast. The sixth, seventh and eighth caster wheels are six inches in diameter and respectively hung 18, 19, and 20 feet from the top of the mast and have a clearance gap of 0.943 inch, 1.009 inch, and 1.076 inch relative to a sixth seventh and eight point on the inner wall of the tapering or conical mast. Suitably, the washers are stacked sufficiently to fill the gaps between the casters such that the stacked washers between the first and second casters, the second and third caster, the fourth and fifth casters, the sixth and seventh casters, and the seventh and eighth caster are all one foot thick where the stacked washers between the third and fourth casters are five foot thick (60 inches) and the stacked washers between the fifth and sixth washers are five foot thick (60 inches) this strategic placement helps maintain a consistent gap ratio along the length of the tapered structure. A shaft collar is installed near the top, and a thimble eye attachment is created on the free end for securing the damper to the mast top cap plate.

In practice, the thimble eye end of the damper assembly is pulled into the top section of the lightning mast from the bottom end of the top section and securely attached using a round pin chain shackle. Once the damper is in place, the assembly of the lightning mast structure is completed, finalizing the installation. This method ensures that the damper effectively reduces resonance vibrations by engaging the mast's interior walls consistently, even with tapered structures, thanks to the strategic placement and sizing of caster wheels.

The cable damper offers several advantages over traditional methods. It provides improved effectiveness in dampening vibrations, has a longer lifespan than PVC-covered chain dampers, and maintains consistent performance across the length of tapered structures. Additionally, it reduces noise and potential for structural damage while requiring lower maintenance compared to tension cable systems. The use of caster wheels minimizes impact noise, enhancing the damper's suitability for conical masts.

The primary application for this cable damper is in electric utility substations, specifically for tall lightning mast structures ranging from 50′ to over 100′ in height. By effectively mitigating wind-induced vibrations, this invention contributes to the longevity and reliability of critical infrastructure in electrical power systems.

The disclosed cable damper system provides a practical, predictable, and inexpensive solution for managing wind-induced vibrations in lightning masts. By utilizing a hanging cable system threaded through washers and caster wheels, the damper addresses the challenges posed by tapered mast structures, offering significant improvements over traditional damping methods. This innovative design ensures uniform engagement with the mast, minimizing variations in the gap ratio between the damper and the mast's sidewall caused by the mast's taper and enhancing damping efficiency.

Although the method and apparatus are described above in terms of various exemplary embodiments and implementations, it should be understood that the various features, aspects, and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more,” or the like; and adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to,” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts, and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein. All scientific journals and patent documents cited in this specification or any accompanying information disclosure sheet (IDS) are hereby incorporated by reference in their entirety.

I claim:

1. A damper comprising:
a. a cable;
b. a set of washers threaded by the cable;
c. said set of washers sandwiched between a two casters, such that one of the two casters has an spanner bushing that is threaded by the cable and located on one side of the set of washers and such
that another one of the two casters has an spanner bushing that is threaded by the cable and located on another side of the set of washers.

2. The damper of claim 1 where the one casters is rotatable around the spanner bushing that is one the one side of the set of washers and the other one of the two casters is rotatable around the spanner bushing that is one the other side of the set of washers.

3. The damper of claim 2 where the set of washers is defined by a plurality of washers.

4. The damper of claim 3 where the one of the plurality of washers interfaces with an the one spanner bushing and where another one of the plurality of washers interfaces with the other spanner bushing.

5. The damper of claim 4 where the washers are 1/16 inch thick and have an outer diameter of 1 to 3 inches.

6. The damper of claim 5 where the one caster is between 2.5 and 8 inches in diameter and 1 to 2 inches thick.

7. The damper of claim 6 where the other caster has a larger diameter than the one caster.

8. The damper of claim 7 where set of washers is 12 inches thick.

9. The damper of claim 8 where the damper further comprises a second set of washers that is threaded by the cable.

10. The damper of claim 9 where the damper further comprises a third caster such that the second set of washers is sandwiched between the other one of the two casters and the third caster.

11. The damper of claim 10 where the third caster features an spanner bushing that is threaded by the cable and located on one side of the second set of washers.

12. A method of damping the vibrations of a lightning diverter mast, said method comprising the steps of: hanging a damper in the mast; while the mast sways, shifting the interfaces of a set of washers that have been threaded by a cable of the damper to produce friction; while the mast sways, shifting the interface of an spanner bushing of a caster and a washer within the set of washers; after the mast sways, impacting the inside of a mast via a the caster, where the spanner bushing is threaded by the cable of the damper; rotating the caster around the spanner bushing after the caster has impacted the side wall of the mast.

13. A method of assembling a mast with a damper comprising the steps of:
a. threading washers and caster wheels onto a cable;
b. hanging the cable in a tapering or conical mast via an eye of the cable;
c. ensuring the clearance gap between the tread of a first of the caster wheels and a first point on the inner wall of the conical mast is within ±7% of the clearance gap between the tread of a second of the caster wheels and a second point on the inner wall of the conical mast.

14. The method of claim 13 where the mast is 100 feet tall and a features a slope or taper of approximately 0.066288 inches per foot.

15. The method of claim 14 where the first caster wheel has a four inch diameter and a clearance gap of 0.949 inch relative to the first point on the inner wall of the tapering or conical mast, the second caster wheel has a four inch diameter and a clearance gap of 1.015 inch relative to the second point on the inner wall of tapering or conical mast, and the third caster wheel has a clearance gap of 1.081 inch relative to a third point on the inner wall of the tapering or conical mast.

16. The method of claim 15 where the fourth caster wheel has a five inch diameter and a clearance gap of 0.979 inch relative to a fourth point on the inner wall of the tapering or conical mast and the fifth caster wheel has a five inch diameter and a clearance gap of 1.045 inch relative to a fifth point on the inner wall of the tapering or conical mast.

17. The method of claim 16 where the sixth, seventh and eighth caster wheels are six inches in diameter and respectively have a clearance gap of 0.943 inch, 1.009 inch, and 1.076 inch relative to a sixth seventh and eight point on the inner wall of the tapering or conical mast.

18. The method of claim 17 where a plurality of the washers is sandwiched between the first and second caster wheels such that one of the washers in the plurality of washers abuts the spanner bushing of the first caster wheel and another one of the washers in the plurality of washers abuts the spanner bushing of the second caster wheel.

19. The method of claim 18 where the washers are between 1/16″ and ⅜″ thick and between 1 and 3 inches in diameter.

20. The method of claim 19 where the caster wheels are a material selected from the following group of materials: polyurethane, neoprene, thermo-pro rubber, phenolic, or glass-filled nylon.
